(19) United States
(12) Patent Application Publication
(10) Pub. No.: US 2015/0175874 A1
(43) Pub. Date: Jun. 25, 2015

(54) WELL PROPPANT AND METHOD FOR RECOVERING HYDROCARBON FROM HYDROCARBON-BEARING FORMATION

(71) Applicant: Asahi Glass Company, Limited, Tokyo (JP)

(72) Inventors: Katsuya UENO, Tokyo (JP); Kazuhiro KUNISADA, Tokyo (JP); Kohta YAMADA, Tokyo (JP); Toshinori TOMITA, Tokyo (JP); Keisuke MORI, Tokyo (JP); Tsuyoshi IWASA, Tokyo (JP)

(73) Assignee: Asahi Glass Company, Limited, Tokyo (JP)

(21) Appl. No.: 14/638,315

(22) Filed: Mar. 4, 2015

Related U.S. Application Data
(63) Continuation of application No. PCT/JP2013/072892, filed on Aug. 27, 2013.

(30) Foreign Application Priority Data
Sep. 20, 2012 (JP) 2012-206853

(51) Int. Cl. C09K 8/588; C09K 8/80; E21B 43/267

(52) U.S. Cl. CPC C09K 8/588; E21B 43/267; C09K 8/805

(57) ABSTRACT

To provide a well proppant containing fluororesin-coated particles which has a sufficiently small frictional resistance of the surface, which has sufficient chemical resistance and strength, which can be produced with high productivity, of which proppant particles as a base substrate are hardly corroded, and in which the adhesion between the coating fluororesin and the proppant particles as a base substrate is high, and a method for efficiently recovering hydrocarbons from a hydrocarbon-bearing formation.

A well proppant containing fluororesin-coated particles having at least part of the surface of proppant particles coated with a fluororesin (F) having a volume flow rate of from 0.1 to 1000 mm³/sec, and a method for recovering hydrocarbons, which comprises a step of injecting a fluid containing the well proppant into a hydrocarbon-bearing formation 14 through a well 10 to support fractures 14a in the hydrocarbon-bearing formation 14, by the well proppant and a step of recovering hydrocarbons through the well 10 from the hydrocarbon-bearing formation 14 in which the fractures 14a are supported by the well proppant.

### TECHNICAL FIELD

The present invention relates to a well proppant for supporting fractures in a hydrocarbon-bearing formation, and a method for recovering hydrocarbons from a hydrocarbon-bearing formation in which fractures are supported by the well proppant.

### BACKGROUND ART

Along with advancement of technology, a method for recovering hydrocarbons (natural gas, petroleum, etc.) from a hydrocarbon-bearing formation which has been considered to be difficult (for example, a method for recovering natural gas (shale gas) from a formation containing shale) has been developed and attracted attention.

As a method for recovering hydrocarbons from a hydrocarbon-bearing formation, a method has been proposed in which fractures are formed in the hydrocarbon-bearing formation, and hydrocarbons gathering in spaces in the hydrocarbon-bearing formation are recovered by means of the fractures has been proposed.

Further, as a method for forming fractures in the hydrocarbon-bearing formation, hydraulic fracturing has been proposed by which a fracturing fluid (water containing a well proppant (such as sand) and additives) is injected under high pressure into a well (gas well or oil well) drilled to the hydrocarbon-bearing formation to form fractures in the hydrocarbon-bearing formation in the vicinity of the well, and the fractures are supported by the well proppant.

For a well proppant, the following are required. That is, (i) the well proppant will not be broken by collision of the well proppant particles when the fracturing fluid is injected under high pressure, (ii) the well proppant can smoothly enter the fractures in the hydrocarbon-bearing formation and can be disposed efficiently at positions where it can support the fractures when the fractures are to be closed, (iii) scales (e.g. barium sulfate) are hardly deposited on the surface of the well proppant, (iv) the well proppant will not resist the flow of a fluid such as hydrocarbons or water so that the fluid will smoothly flow out from the fractures in the hydrocarbon-bearing formation, and (v) the well proppant will not be corroded by various chemicals used in the well, water vapor, etc.

In order to meet the requirement (i) among the above requirements, it is effective to coat the surface of proppant particles with a resin. Further, in order to meet the requirements (i) to (iv), it is effective to reduce the frictional resistance of the surface of the well proppant as far as possible. Further, in order to meet the requirement (v), it is effective to coat the surface of the proppant particles with a chemical-resistant resin. As a well proppant having a small frictional resistance of the surface and which is coated with a chemical-resistant resin, for example, a well proppant containing polytetrafluoroethylene (hereinafter referred to as PTFE)-coated particles having the surface of proppant particles coated with PTFE is disclosed (Patent Document 1).

However, the PTFE-coated particles have the following problems.

(a) Since PTFE cannot be melt-formed, when the surface of the proppant particles is to be coated with PTFE, it is necessary to attach PTFE fine particle on the surface of the proppant particles and to bake the particles at a considerably high temperature, thus leading to low productivity.

(b) At the time of baking, part of PTFE is decomposed at high temperature to form hydrogen fluoride, which corrodes the proppant particles (e.g. sand) as a base substrate.

(c) The adhesion between PTFE and the proppant particles as a base substrate tends to be poor, and PTFE is likely to be peeled.

### PRIOR ART DOCUMENTS

### Patent Documents

Patent Document 1: WO2005/100007 (JP-A-2007-532721)

### DISCLOSURE OF INVENTION

### Technical Problem

The object of the present invention is to provide a well proppant containing fluororesin-coated particles, which has a sufficiently small frictional resistance of the surface, which has sufficient chemical resistance and strength, which can be produced with a high productivity as compared with a conventional well proppant containing PTFE-coated particles, of which the proppant particles as a base substrate are hardly corroded, and in which the adhesion between the proppant particles as a base substrate and the coating fluororesin is high, and a method for efficiently recovering hydrocarbons from a hydrocarbon-bearing formation.

### Solution to Problem

The well proppant of the present invention contains fluororesin-coated particles having at least part of the surface of proppant particles coated with a fluororesin (F) having a volume flow rate of from 0.1 to 1000 mm³/sec.

The fluororesin coated particles are preferably spherical with a sphericity of at least 0.8, and have an average particle size of preferably from 50 to 1000 μm.

The fluororesin (F) is preferably at least one member selected from the group consisting of a copolymer (F1) having either one or both of structural units based on tetrafluoroethylene and structural units based on chlorotrifluoroethylene, polychlorotrifluoroethylene (F2), polyvinylidene fluoride (F3) and a polymer (F4) having a fluorinated alicyclic structure in its main chain.

The copolymer (F1) is preferably at least one member selected from the group consisting of a copolymer having structural units based on tetrafluoroethylene and structural units based on a perfluoro(alkyl vinyl ether), a copolymer having structural units based on tetrafluoroethylene and structural units based on hexafluoropropylene, a copolymer having structural units based on ethylene and structural units based on tetrafluoroethylene, and a copolymer having structural units based on ethylene and structural units based on chlorotrifluoroethylene.

The polymer (F4) is preferably a polymer obtainable from at least one monomer selected from the group consisting of the following compounds (6), (7) and (8):

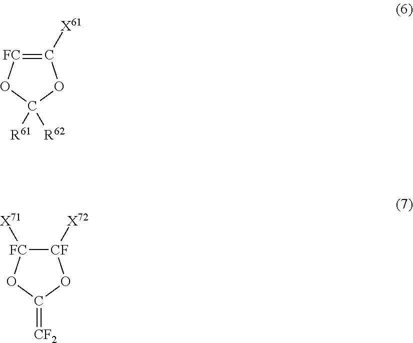

wherein X⁶¹ is a fluorine atom or a C₁₋₃ perfluoroalkoxy group,

each of R⁶¹ and R⁶² which are independent of each other, is a fluorine atom or a C₁₋₆ perfluoroalkyl group, and

each of X⁷¹ and X⁷² which are independent of each other, is a fluorine atom or a C₁₋₉ perfluoroalkyl group;

CF₂═CF-Q-CF═CF₂ (8)

wherein Q is a C₁₋₃ perfluoroalkylene group (which may have an etheric oxygen atom).

The fluororesin (F) may have at least one type of functional groups selected from the group consisting of a —C(O)O— group, a —OC(O)O— group, a —OH group, a —C(O)OH group, a —C(O)X group (wherein X is a halogen atom) and a C(O)OC(O)— group.

The method for recovering hydrocarbons of the present invention comprises a step of injecting a fluid containing the well proppant of the present invention into a hydrocarbon-bearing formation through a well to support fractures in the hydrocarbon-bearing formation by the well proppant, and a step of recovering hydrocarbons through the well from the hydrocarbon-bearing formation in which the fractures are supported by the well proppant.

### Advantageous Effects of Invention

The well proppant of the present invention has a sufficiently small frictional resistance of the surface and has sufficient chemical resistance and strength, and as compared with a conventional well proppant containing PTFE-coated particles, it is produced with high productivity and contains fluororesin-coated particles of which proppant particles as a base substrate are hardly corroded and in which the adhesion between a coating fluororesin and the proppant particles as a base substrate is high, and it has high durability as compared with a conventional product.

Further, according to the method for recovering hydrocarbons of the present invention, hydrocarbons can efficiently be recovered from a hydrocarbon-bearing formation.

### BRIEF DESCRIPTION OF DRAWINGS

FIG. 1 is a drawing schematically illustrating an example of a well to recover hydrocarbons from a hydrocarbon-bearing formation.

FIG. 2 is a view schematically illustrating an apparatus used to measure an oil recovery time and an oil recovery amount.

### DESCRIPTION OF EMBODIMENTS

In this specification, a compound represented by the formula (1) will be referred to as a compound (1). The same applies to compounds represented by other formulae.

The following definition of terms applies to the present specification and claims.

Proppant particles are particles to be a base substrate of fluororesin-coated particles.

A fluororesin is a polymer having structural units based on a monomer having fluorine atoms.

Coating means that the surface of proppant particles as a base substrate is covered with a film-form fluororesin, or fine particles of a fluororesin are attached to the surface of proppant particles as a base substrate.

Fluororesin-coated particles are particles having at least part of the surface of proppant particles as a base substrate coated with a fluororesin.

The well proppant of the present invention is a proppant containing at least fluororesin-coated particles, and may contain known proppant particles other than the fluororesin-coated particles.

A monomer is a compound having a polymerizable carbon-carbon double bond.

Structural units are units derived from a monomer formed by polymerization of the monomer.

Structural units may be units directly formed by polymerization, or may be units having part of the units converted to another structure by treating the polymer.

“Having a fluorinated alicyclic structure in its main chain” means that at least one carbon atom constituting a fluorinated aliphatic ring in a polymer is a carbon atom constituting the main chain of the polymer, and atoms constituting the fluorinated aliphatic ring may include an oxygen atom, a nitrogen atom and the like in addition to carbon atoms.

A main chain is a linear molecular chain such that all the molecular chains other than the main chain are considered as side chains.

A perfluoroalkyl group is a group having all the hydrogen atoms in an alkyl group substituted with fluorine atoms.

A perfluoroalkylene group is a group having all the hydrogen atoms in an alkylene group substituted with fluorine atoms.

A fluid means a liquid or a gas, and may contain a solid such as particles so long as properties as a fluid are not lost.

A well means a gas well or an oil well.

A hydrocarbon-bearing formation means a formation containing either one or both of gaseous hydrocarbons (such as natural gas) and liquid hydrocarbons (such as petroleum).

A formation means a layer of aggregates of clay, sand, gravel, volcanish ash, remains of organisms, etc.

Hydrocarbons are compounds consisting solely of carbon atoms and hydrogen atoms.

A volume flow rate (Q value) is an index of melt fluidity of a fluororesin and a measure of a molecular weight. A high Q value indicates a low molecular weight, and a low Q value indicates a high molecular weight. The Q value in the present invention is an extrusion rate when a fluororesin is extruded into an orifice having a diameter of 2.1 mm and a length of 8 mm at a temperature higher by 50° C. than the melting point of the fluororesin under a load of 7 kg, using Flow Tester manufactured by Shimadzu Corporation.

The proportion of structural units is obtained by a known method from results of melt NMR analysis, fluorine content analysis and infrared absorption spectrum analysis.

Spherical means a sphericity of at least 0.8.

The sphericity is obtained in such a manner that 20 particles are randomly selected by observation with an electron microscope, and the major axis and the minor axis of each particle are measured to obtain a sphericity (minor axis/major axis), and sphericities of the 20 particles are averaged.

The average particle size is obtained in such a manner that 20 particles are randomly selected by observation with an electron microscope, and the particle size of each particle is measured, and particle sizes of the 20 particles are averaged.

### <Well Proppant>

The well proppant of the present invention contains fluororesin-coated particle having at least part of the surface of proppant particles coated with a fluororesin (F) having a volume flow rate (hereinafter referred to as Q value) of from 0.1 to 1000 mm³/sec, preferably from 1 to 500 mm³/sec. The well proppant of the present invention may contain known proppant particles other than the fluororesin-coated particles within a range not to impair the effects of the present invention. The well proppant of the present invention preferably consists solely of fluororesin-coated particles, whereby the effects of the present invention can be made best use of.

### (Proppant Particles)

The proppant particles may be known proppant particles to be used for a well, such as natural sand, artificial sand (such as a ceramic) or resin-coated sand.

The proppant particles are preferably spherical, whereby the above-described requirements (i) to (iv) can be sufficiently met.

### (Fluororesin (F))

The fluororesin (F) in the present invention is a fluororesin which can be melt-formed, that is, a fluororesin having a Q value of from 0.1 to 1000 mm³/sec.

The Q value of the fluororesin (F) is from 0.1 to 1000 mm³/sec, preferably from 5 to 500 mm³/sec, more preferably from 10 to 200 mm³/sec. When the Q value is at least 0.1mm³/sec, such a fluororesin can be melt-formed and used to coat the surface of the proppant particles. When the Q value is at most 1000 mm³/sec, the strength of the fluororesin (F) is sufficiently high.

PTFE is a fluororesin which cannot be melt-formed, and its Q value cannot be measured (almost 0 mm³/sec).

The fluororesin (F) is preferably at least one member selected from the group consisting of a copolymer (F1) having either one or both of structural units based on tetrafluoroethylene (hereinafter referred to as TFE) and structural units based on chlorotrifluoroethylene (hereinafter referred to as CTFE), polychlorotrifluoroethylene (F2) (hereinafter referred to as PCTFE), polyvinylidene fluoride (F3) (hereinafter referred to as PVdF) and a polymer (F4) having a fluorinated alicyclic structure in its main chain, which is easily melt-formed, which has a sufficiently small frictional resistance, which has sufficient chemical resistance and strength, and which has a high adhesion with the proppant particles.

### (Copolymer (F1))

The copolymer (F1) is preferably a copolymer (F11) having structural units (a) and structural units (b) or a copolymer (F12) having structural units (a) and structural units (d), which is easily melt-formed, which has a sufficiently small frictional resistance, which has sufficient chemical resistance and strength, and which has a high adhesion with the proppant particles, and is more preferably a copolymer (F13) having structural units (a), structural units (b) and structural units (c), which is particularly excellent in the adhesion with the proppant particles.

Structural units (a):

Structural units (a) are either one or both of structural units based on TFE and structural units based on CTFE.

Structural units (b):

Structural units (b) are structural units based on a monomer having fluorine atoms (excluding TFE and CTFE).

The monomer having fluorine atoms may be the following compounds.

Vinyl fluoride,

vinylidene fluoride (hereinafter referred to as VdF),

trifluoroethylene,

hexafluoropropylene (hereinafter referred to as HFP),

CF₂═CFOR¹¹ (1),

CF₂═CFOR²¹SO₂X²¹ (2),

CF₂═CFOR³¹CO₂X³¹ (3),

CF₂═CF(CF₂)ₚOCF═CF₂ (4),

CH₂═CX⁵¹(CF₂)_{q}X⁵² (5),

perfluoro(4-methyl-1,3-dioxol),

perfluoro(2,2-dimethyl-1,3-dioxol) and the like.

R¹¹ is a C₁₋₁₀ perfluoroalkyl group which may contain an oxygen atom between carbon atoms.

R²¹ is a C₁₋₁₀ perfluoroalkylene group which may contain an oxygen atom between carbon atoms.

X²¹ is a halogen atom or hydroxy group.

R³¹ is a C₁₋₁₀ perfluoroalkylene group which may contain an oxygen atom between carbon atoms.

X³¹ is a hydrogen atom or an alkyl group having at most 3 carbon atoms.

p is 1 or 2.

X⁵¹ is a hydrogen atom or a fluorine atom.

q is an integer of from 2 to 10.

X⁵² is a hydrogen atom or a fluorine atom.

The compound (1) may be the following compounds.

CF₂═CFOCF₃ (1-1),

CF₂═CFOCF₂CF₃ (1-2),

CF₂═CFOCF₂CF₂CF₃ (1-3),

CF₂═CFOCF₂CF₂CF₂CF₃ (1-4),

CF₂═CFO(CF₂)₈F (1-5), and the like.

The compound (5) may be the following compounds.

CH₂═CH(CF₂)₂F (5-1),

CH₂═CH(CF₂)₃F (5-2),

CH₂═CH(CF₂)₄F (5-3),

CH₂═CH(CF₂)₆F (5-4),

CH₂═CF(CF₂)₃H (5-5),

CH₂═CF(CF₂)₄H (5-6), and the like.

Structural units (c):

Structural units (c) are structural units based on an acid anhydride having a polymerizable carbon-carbon double bond.

The acid anhydride having a polymerizable carbon-carbon double bond may be the following compounds.

Itaconic anhydride (hereinafter referred to as IAH),

citraconic anhydride (hereinafter referred to as CAH),

5-norbornene-2,3-dicarboxylic anhydride (hereinafter referred to as NAH),

maleic anhydride, and the like.

Structural units (d):

Structural units (d) are structural units based on a monomer having no fluorine atom (excluding acid anhydride having a polymerizable carbon-carbon double bond).

The monomer having no fluorine atom may be the following compounds.

An olefin having at most 3 carbon atoms:ethylene (hereinafter referred to as E), propylene (hereinafter referred to as P), and the like,

a vinyl ester:vinyl acetate (hereinafter referred to as VOA), and the like,

a vinyl ether:ethyl vinyl ether, cyclohexyl vinyl ether, and the like.

### (Copolymer (F11))

The copolymer (F11) is a copolymer having structural units (a) and structural units (b) and may have structural units (d) as the case requires.

The copolymer (F11) is preferably a copolymer having structural units based on TFE and structural units based on a perfluoro(alkyl vinyl ether) (compound (1)) (hereinafter referred to as PFA) or a copolymer having structural units based on TFE and structural units based on HFP (hereinafter referred to as FEP), which is easily melt-formed, which has a sufficiently small frictional resistance, which has sufficient chemical resistance and strength, and which has a high adhesion with the proppant particles.

PFA:

The proportion of the structural units based on TFE is preferably from 90 to 99.8 mol %, more preferably from 93 to 99.5 mol %, further preferably from 95 to 99 mol % per 100 mol % of the total of the structural units based on TFE and the structural units based on the compound (1).

The proportion of the structural units based on the compound (1) is preferably from 0.2 to 10 mol %, more preferably from 0.5 to 7 mol %, further preferably from 1 to 5 mol % per 100 mol % of the total of the structural units based on TFE and the structural units based on the compound (1).

When the proportion of the structural units based on TFE and the proportion of the structural units based on the compound (1) are within the above ranges, the balance of the melt formability, the low friction property, the chemical resistance, the strength and the adhesion will be favorable.

PFA may have structural units based on another monomer. Such another monomer may be the above-described monomer having fluorine atoms (excluding the compound (1)) or monomer having no fluorine atom.

The proportion of the structural units based on another monomer is preferably at most 30 mol %, more preferably from 0.1 to 15 mol %, further preferably from 0.2 to 10 mol % in all the structural units (100 mol %) constituting PFA.

FEP:

The proportion of the structural units based on TFE is preferably from 50 to 98 mol %, more preferably from 60 to 95 mol %, further preferably from 75 to 90 mol % per 100 mol % of the total of the structural units based on TFE and the structural units based on HFP.

The proportion of the structural units based on HFP is preferably from 2 to 50 mol %, more preferably from 5 to 40 mol %, further preferably from 10 to 25 mol % per 100 mol % of the total of the structural units based on TFE and the structural units based on HFP.

When the proportion of the structural units based on TFE and the proportion of the structural units based on HFP are within the above ranges, the balance of the melt formability, the low friction property, the chemical resistance, the strength and the adhesion will be favorable.

FEP may have structural units based on another monomer. Such another monomer may be the above-described monomer having fluorine atoms (excluding HFP) or monomer having no fluorine atom, and is preferably E or VdF.

The proportion of the structural units based on another monomer is preferably at most 30 mol %, more preferably from 0.1 to 15 mol %, further preferably from 0.2 to 10 mol % in all the structural units (100 mol %) constituting FEP.

Another embodiment of copolymer (F11):

The copolymer (F11) may also be preferably the following copolymers.

A copolymer having structural units based on TFE, structural units based on the compound (5-4) and structural units based on E,

a copolymer having structural units based on TFE, structural units based on the compound (5-1) and structural units based on E, and

a copolymer having structural units based on TFE, structural units based on VdF and structural units based on P.

### (Copolymer (F12)):

The copolymer (F12) is a copolymer having structural units (a) and structural units (d) and may have structural units (b) as the case requires.

The copolymer (F12) is preferably a copolymer having structural units based on E and structural units based on TFE (hereinafter referred to as ETFE) or a copolymer having structural units based on E and structural units based on CTFE (hereinafter referred to as ECTFE), which is easily melt-formed, which has a sufficiently small frictional resistance, which has sufficient chemical resistance and strength, and which has a high adhesion with the proppant particles.

ETFE:

The proportion of the structural units based on TFE is preferably from 30 to 70 mol %, more preferably from 40 to 65 mol %, further preferably from 40 to 60 mol % per 100 mol % of the total of the structural units based on TFE and the structural units based on E.

The proportion of the structural units based on E is preferably from 30 to 70 mol %, more preferably from 35 to 60 mol %, further preferably from 40 to 60 mol % per 100 mol % of the total of the structural units based on TFE and the structural units based on E.

When the proportion of the structural units based on TFE and the proportion of the structural units based on E are within the above ranges, the balance of the melt formability, the low friction property, the chemical resistance, the strength and the adhesion will be favorable.

ETFE may have structural units based on another monomer. Such another monomer may be the above-described monomer having fluorine atoms or monomer having no fluorine atom (excluding E).

The proportion of the structural units based on another monomer is preferably at most 30 mol %, more preferably from 0.1 to 15 mol %, further preferably from 0.2 to 10 mol % in all the structural units (100 mol %) constituting ETFE.

ECTFE:

The proportion of the structural units based on CTFE is preferably from 30 to 70 mol %, more preferably from 40 to 65 mol %, further preferably from 40 to 60 mol % per 100 mol % of the total of the structural units based on CTFE and the structural units based on E.

The proportion of the structural units based on E is preferably from 30 to 70 mol %, more preferably from 35 to 60 mol %, further preferably from 40 to 60 mol % per 100 mol % of the total of the structural units based on CTFE and the structural units based on E.

When the proportion of the structural units based on CTFE and the proportion of the structural units based on E are within the above ranges, the balance of the melt formability, the low friction property, the chemical resistance, the strength and the adhesion will be favorable.

ECTFE may have structural units based on another monomer. Such another monomer may be the above-described monomer having fluorine atoms or monomer having no fluorine atom (excluding E).

The proportion of the structural units based on another monomer is preferably at most 30 mol %, more preferably from 0.1 to 15 mol %, further preferably from 0.2 to 10 mol % in all the structural units (100 mol %) constituting ECTFE.

Another embodiment of copolymer (F12):

The copolymer (F12) may also be preferably the following copolymer.

A copolymer having structural units based on TFE and structural units based on P.

### (Copolymer (F13)):

The copolymer (F13) is a copolymer having structural units (a), structural units (b) and structural units (c) and may have structural units (d) as the case requires.

The monomer having fluorine atoms constituting the structural units (b) is preferably VdF, HFP, the compound (1) or the compound (5), more preferably the compound (1) or the compound (5).

The compound (1) is preferably the compound (1-2) or the compound (1-3), more preferably the compound (1-3).

The compound (5) is preferably the compound (5-1) or the compound (5-4).

The acid anhydride constituting the structural units (c) is preferably IAH, CAH or NAH, more preferably IAH or CAH, whereby a copolymer having —C(O)OC(O)— groups may readily be produced without using a special polymerization method (see JP-A-11-193312) which is necessary in the case of using maleic anhydride.

The copolymer (F13) may have structural units based on a dicarboxylic acid such as itaconic acid, citraconic acid, 5-norbornene-2,3-dicarboxylic acid or maleic acid, formed by hydrolysis of the acid anhydride. In a case where the copolymer (F13) has structural units based on the dicarboxylic acid, the proportion of the structural units (c) is the total of the structural units based on the acid anhydride and the structural units based on the dicarboxylic acid.

The monomer having no fluorine atom constituting the structural units (d) is preferably E, P or VOA, more preferably E.

The proportion of the structural units (a) is preferably from 50 to 99.89 mol %, more preferably from 50 to 99.4 mol %, further preferably from 50 to 98.9 mol % per 100 mol % of the total of the structural units (a) to (c).

The proportion of the structural units (b) is preferably from 0.1 to 49.99 mol %, more preferably from 0.5 to 49.9 mol %, further preferably from 1 to 49.9 mol % per 100 mol % of the total of the structural units (a) to (c).

The proportion of the structural units (c) is preferably from 0.01 to 5 mol %, more preferably from 0.1 to 3 mol %, further preferably from 0.1 to 2 mol % per 100 mol % of the total of the structural units (a) to (c).

When the proportions of the structural units (a) to (c) are within the above ranges, the balance of the melt formability, the low friction property, the chemical resistance, the strength and the adhesion will be favorable.

When the proportion of the structural units (c) is within the above range, the adhesion with the proppant particles will be higher.

The total proportion of the structural units (a) to (c) is preferably at least 60 mol %, more preferably at least 65 mol %, further preferably at least 68 mol %, particularly preferably from 70 to 99 mol % in all the structural units (100 mol %) constituting the copolymer (F13).

In a case where the copolymer (F13) has structural units (d), the proportion of the structural units (d) is preferably from 5 to 90 mol %, more preferably from 5 to 80 mol %, further preferably from 10 to 66 mol %, per 100 mol % of the total of the structural units (a) to (c).

The copolymer (F13) is preferably the following copolymers.

A copolymer having structural units based on TFE, structural units based on the compound (1-3) and structural units based on IAH,

a copolymer having structural units based on TFE, structural units based on the compound (1-3) and structural units based on CAH,

a copolymer having structural units based on TFE, structural units based on HFP and structural units based on IAH,

a copolymer having structural units based on TFE, structural units based on HFP and structural units based on CAH,

a copolymer having structural units based on TFE, structural units based on VdF and structural units based on IAH,

a copolymer having structural units based on TFE, structural units based on VdF and structural units based on CAH,

a copolymer having structural units based on TFE, structural units based on the compound (5-4), structural units based on IAH and structural units based on E,

a copolymer having structural units based on TFE, structural units based on the compound (5-4), structural units based on CAH and structural units based on E,

a copolymer having structural units based on TFE, structural units based on the compound (5-1), structural units based on IAH and structural units based on E,

a copolymer having structural units based on TFE, structural units based on the compound (5-1), structural units based on CAH and structural units based on E,

a copolymer having structural units based on CTFE, structural units based on the compound (5-4), structural units based on IAH and structural units based on E,

a copolymer having structural units based on CTFE, structural units based on the compound (5-4), structural units based on CAH and structural units based on E,

a copolymer having structural units based on CTFE, structural units based on the compound (5-1), structural units based on IAH and structural units based on E,

a copolymer having structural units based on CTFE, structural units based on the compound (5-1), structural units based on CAH and structural units based on E.

### (Polymer (F4))

The polymer (F4) is an amorphous or non-crystalline polymer having a fluorinated alicyclic structure in its main chain.

The fluorinated alicyclic ring is preferably a fluorinated alicyclic ring having from 1 to 2 oxygen atom(s). The number of atoms constituting the fluorinated alicyclic ring is preferably from 4 to 7.

The polymer (F4) is obtained by polymerizing a monomer component containing a fluorinated monomer capable of forming the polymer. Such a fluorinated monomer may be a cyclic monomer having a carbon-carbon double bond and a fluorinated alicyclic structure, in which at least one carbon atom constituting the carbon-carbon double bond constitutes a part of the fluorinated alicyclic structure, or a linear diene monomer having two carbon-carbon double bonds.

At least one carbon atom constituting the fluorinated alicyclic ring is a carbon atom constituting the main chain of the polymer. The carbon atoms constituting the main chain derive from carbon atoms of the carbon-carbon double bond in the case of the polymer obtained by polymerizing the cyclic monomer, or derive from 4 carbon atoms of the two carbon-carbon double bonds in the case of the polymer obtained by cyclopolymerization of the diene monomer.

In each of the cyclic monomer and the diene monomer, the proportion of the number of fluorine atoms bonded to carbon atoms relative to the total number of hydrogen atoms bonded to carbon atoms and fluorine atoms bonded to carbon atoms is preferably at least 80%, particularly preferably 100%.

The cyclic monomer is preferably a compound (6) or a compound (7):

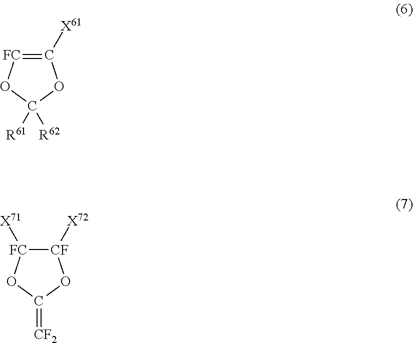

wherein X⁶¹ is a fluorine atom or a C₁₋₃ perfluoroalkoxy group,

each of R⁶¹ and R⁶² which are independent of each other, is a fluorine atom or a C₁₋₆ perfluoroalkyl group, and

each of X⁷¹ and X⁷² which are independent of each other, is a fluorine atom or a C₁₋₉ perfluoroalkyl group.

The compound (6) may, for example, be compounds (6-1) to (6-3):

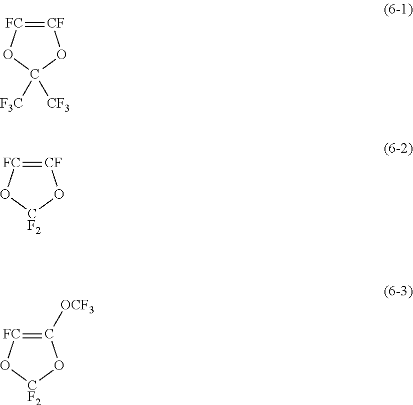

The compound (7) may, for example, be compounds (7-1) and (7-2):

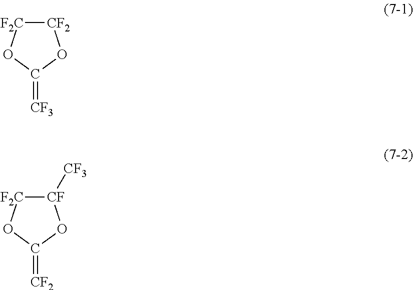

The diene monomer is preferably a compound (8):

CF₂═CF-Q-CF═CF₂ (8)

Q is a C₁₋₃ perfluoroalkylene group (which may have an etheric oxygen atom). In the case of a perfluoroalkylene group having an etheric oxygen atom, the etheric oxygen atom may be present at one terminal of the group, may be present at both terminals of the group, or may be present between carbon atoms of the group. In view of cyclopolymerizability, it is preferably present at one terminal of the group.

By cyclopolymerization of the compound (8), a polymer (F4) having structural units of at least one of the following (α) to (γ) is obtained:

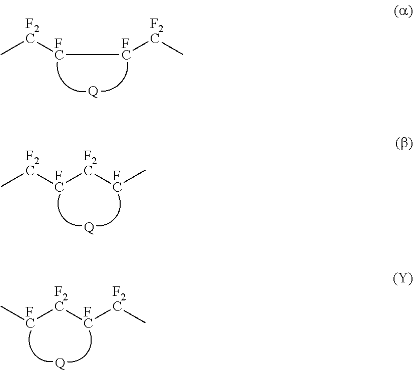

The compound (8) may, for example, be compounds (8-1) to (8-9):

CF₂═CFOCF₂CF═CF₂ (8-1),

CF₂═CFOCF(CF₃)CF═CF₂ (8-2),

CF₂═CFOCF₂CF₂CF═CF₂ (8-3),

CF₂═CFOCF(CF₃)CF₂CF═CF₂ (8-4),

CF₂═CFOCF₂CF(CF₃)CF═CF₂ (8-5),

CF₂═CFOCF₂OCF═CF₂ (8-6),

CF₂═CFOC(CF₃)₂OCF═CF₂ (8-7),

CF₂═CFCF₂CF═CF₂ (8-8),

CF₂═CFCF₂CF₂CF═CF₂ (8-9).

The proportion of the structural units having a fluorinated alicyclic structure is preferably at least 20 mol %, more preferably at least 40 mol %, further preferably 100 mol % in all the structural units (100 mol %) constituting the polymer (F4). The structural units having a fluorinated alicyclic structure are structural units formed by polymerization of the cyclic monomer or structural units formed by cyclopolymerization of the diene monomer.

The structure of a polymer obtained by cyclopolymerization of the compound (8-3) is as follows:

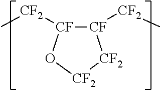

### (Specific Functional Group)

The fluororesin (F) may have at least one type of functional groups selected from the group consisting of a —C(O)O— group (an ester group), a —OC(O)O— group (a carbonate group), a —OH groups (a hydroxy group), a —C(O)OH group (a carboxy group), a —C(O)X group (wherein X is a halogen atom) (a carbonyl halide group) and a —C(O)OC(O)— group (an acid anhydride residue).

The functional groups are preferably ester groups, hydroxy groups, acid anhydride residue or the like.

The functional groups may be introduced by properly selecting the monomer, a radical polymerization initiator, a chain transfer agent and the like used at the time of production of the fluororesin (F).

The radical polymerization initiator for introducing functional groups is preferably one having a carbonate group. It may, for example, be preferably an organic peroxide such as diisopropylperoxycarbonate, di-n-propylperoxydicarbonate, t-butylperoxyisopropylcarbonate, bis(4-t-butylcyclohexyl)peroxydicarbonate or di-2-ethylhexylperoxydicarbonate.

The chain transfer agent for introducing functional groups is preferably one having a hydroxy group, an ester group or a carboxy group. It may, for example, be an alcohol such as methanol, ethanol, propanol or butanol, ethyl acetate, acetic acid, acetic anhydride or thioglycolic acid.

### (Method for Producing Fluororesin (F))

The fluororesin (F) may be produced by polymerizing the above-described monomers by a known polymerization method (such as a bulk polymerization method, a solution polymerization method, a suspension polymerization method or an emulsion polymerization method) using a known radical polymerization initiator and as the case requires, a known chain transfer agent.

### (Fluororesin-Coated Particles)

The fluororesin-coated particles are particles having at least part of the surface of the proppant particles coated with the fluororesin (F). It is preferred that the entire surface of the proppant particles is coated with the fluororesin (F), whereby the effects of the present invention can be sufficiently obtained.

The fluororesin-coated particles are preferably spherical, whereby the above-described requirements (i) to (iv) can be sufficiently met.

The average particle size of the fluororesin-coated particles is preferably from 50 to 1000 μm, more preferably from 150 to 850 μm. When the average particle size is at least 50 μm, the fractures can be sufficiently supported in the hydrocarbon-bearing formation, and the efficiency of the recovery of hydrocarbons will be higher. When the average particle size is at most 1000 μm, the particles will more smoothly enter the hydrocarbon-bearing formation through the fractures.

### (Method for Producing Fluororesin-Coated Particles)

The fluororesin-coated particles may be produced by coating at least part of the surface of the proppant particles with the fluororesin (F) by a known coating method.

The coating method may, for example, be the following methods.

(1) A method of applying a solution of the fluororesin (F) to the surface of the proppant particles by a known coating method (such as a dipping method or a spray method) and drying the solution to cover the surface of the proppant particles with a coating film of the fluororesin (F).

(2) A method of covering the surface of the proppant particles with a film of the fluororesin (F), and shrinking the film by heating for contact-bonding.

(3) A method of attaching fine particles of the fluororesin (F) to the surface of the proppant particles, followed by baking to contact-bond the fine particle of the fluororesin (F) to the surface of the proppant particles.

(4) A method of attaching fine particles of the fluororesin (F) to the surface of the proppant particles, followed by baking to melt the fine particles of the fluororesin (F) thereby to cover the surface of the proppant particles with a coating film of the fluororesin film (F).

(5) A method of coating the surface of the proppant particles with the fluororesin (F) by a plasma spray coating method.

Among the above coating methods, preferred is (1), (4) or (5), and particularly preferred is (1) or (4).

Coating may be carried out before a fluid containing the well proppant is injected into the hydrocarbon-bearing formation, during injection of a fluid containing the well proppant into a hydrocarbon-bearing formation, or after a fluid containing the well proppant is injected into a hydrocarbon-bearing formation. Particularly, coating is carried out preferably before a fluid containing the well proppant is injected into a hydrocarbon-bearing formation.

### (Functional Effect)

Since the above-described well proppant of the present invention contains fluororesin-coated particles having at least part of the surface of proppant particles coated with a fluororesin, it has sufficiently small frictional resistance of the surface and has sufficient chemical resistance and strength.

Further, since the fluororesin is a fluororesin (F) having a Q value of from 0.1 to 1000 mm³/sec, the temperature at the time of coating the surface of the proppant particles with the fluororesin (F) can be made low as compared with PTFE. Therefore, the productivity is high as compared with a conventional well proppant containing PTFE-coated particles. Further, hydrogen fluoride is less likely to be formed, and thus the proppant particles are hardly corroded.

Further, since the fluororesin (F) has good adhesion as compared with PTFE, the adhesion between the coating fluororesin (F) and the proppant particles tends to be high.

### <Method for Recovering Hydrocarbons>

The method for recovering hydrocarbons of the present invention comprises the following steps.

(I) A step of injecting a fluid containing the well proppant of the present invention into a hydrocarbon-bearing formation through a well to support fractures in the hydrocarbon-bearing formation by the well proppant.

(II) A step of recovering hydrocarbons through the well from the hydrocarbon-bearing formation in which the fractures are supported by the well proppant.

### (Step (I))

The fluid containing the well proppant may be a fracturing fluid in a hydraulic fracturing method. The fracturing fluid contains water, the well proppant and additives (such as an acid, a biocide, a breaker, an inhibitor, a crosslinking agent, a friction-reducing agent, a gelling agent, an iron inhibitor, an electrolyte, a deoxidizing agent, a pH adjusting agent, a scale inhibiting agent and a surfactant).

The type and the amount of the fluororesin-coated particles in the fluid containing the well proppant vary depending upon the type, the conditions, etc. of the well. That is, the fluid containing the well proppant and the hydraulic fracturing method using it may properly be changed depending upon the type, the conditions, etc. of the well.

The fluid containing the well proppant may be prepared by mixing water, the well proppant, the additives, etc. by a method using a known apparatus (such as an in-line static mixer or a recirculation pump).

The well may be a gas well or an oil well, and is preferably a gas well.

The hydrocarbon-bearing formation may, for example, be a siliciclastic formation formed by aggregates of crust (such as sand or dirt) or a carbonate formation.

The siliciclastic formation may be a formation containing shale, conglomerate, diatomite, sand, sandstone or the like.

The carbonate formation may be a formation containing limestone, dolomite or the like.

Injection of the fluid containing the well proppant into the hydrocarbon-bearing formation is carried out by a known method, for example, by a method by transport by a pressure pump.

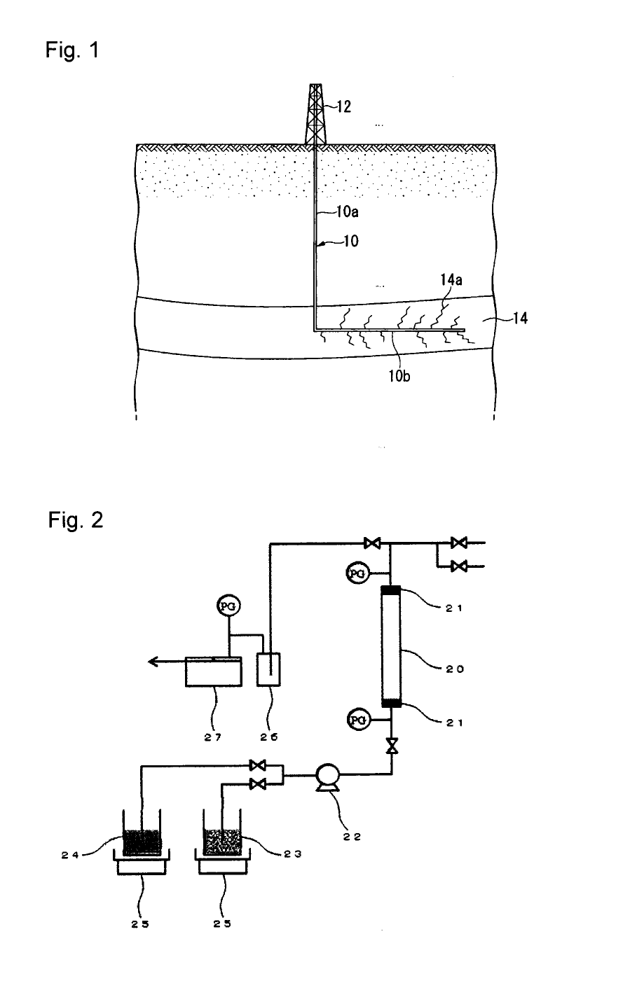

FIG. 1 is a view schematically illustrating an example of a well to recover hydrocarbons from a hydrocarbon-bearing formation. A well 10 has a vertical portion 10a extending from a drill tower 12 on the ground into the ground toward a hydrocarbon-bearing formation 14, and a horizontal portion 10b bending at the bottom of the vertical portion 10a in the hydrocarbon-bearing formation 14 and extending in a substantially horizontal direction.

A fracturing fluid injected under a high pressure from a well head of the well 10 passes through the vertical portion 10a and is injected from openings of the horizontal portion 10b into the hydrocarbon-bearing formation 14 in the vicinity of the well. By the fracturing fluid being injected under a high pressure into the hydrocarbon-bearing formation 14, fractures 14a are formed in the hydrocarbon-bearing formation 14 and the fractures 14a are supported by the proppant contained in the fracturing fluid.

### (Step (II))

Hydrocarbons to be recovered may be gaseous hydrocarbons (such as natural gas) and liquid hydrocarbons (such as petroleum), and may, for example, be specifically methane, ethane, propane, butane, hexane, heptane and octane.

Recovery of the hydrocarbons may be carried out by a known method.

### (Functional Effect)

In the above-described method for recovering hydrocarbons of the present invention, since fractures in the hydrocarbon-bearing formation are supported by the well proppant of the present invention having a small frictional resistance and then hydrocarbons are recovered from the hydrocarbon-bearing formation, hydrocarbons can efficiently be recovered from the hydrocarbon-bearing formation.

### EXAMPLES

Now, the present invention will be described in further detail with reference to Examples and Comparative Examples. However, it should be understood that the present invention is by no means restricted thereto.

The copolymer composition of a fluororesin, the volume flow rate (Q value), the oil recovery time, the oil recovery amount and the coating adhesion were measured by the following methods.

### [Copolymer Composition of Fluororesin]

The composition of a copolymer was determined by analyzing and evaluating measurement results of the melt NMR, the fluorine content and the infrared absorption spectrum.

### [Volume Flow Rate (Q Value)]

Using Flow tester manufactured by Shimadzu Corporation, the extrusion rate of a fluororesin when extruded into an orifice having a diameter of 2.1 mm and a length of 8 mm under a load of 7 kg at a temperature higher by 50° C. than the melting point of the fluororesin was measured.

### [Oil Recovery Time and Oil Recovery Amount]

They were measured by using an apparatus shown in FIG. 2.

First, a stainless tube 20 having an internal capacity of 12.6 ml is filled with a proppant. Then, a stainless tube is impregnated with an oil by a pump 22. Then, the line is switched to a hydraulic injection line, and hydraulic injection is carried out at 1 ml/min. The time was measured simultaneously with hydraulic injection, and the time until discharge of the oil was completed and changed to water, and the volume (ml) of the oil recovered were measured.

### [Coating Adhesion]

10 kg of fluororesin-coated sand was poured into 200 L (liter) granulating tank and stirred for 5 hours, whereupon the amount of a fallen resin powder was confirmed and evaluated based on the standards ◯ (nil: good), Δ (slightly observed: fair), × (significantly observed: poor).

### Example 1

A polymerization tank equipped with a stirrer having an internal capacity of 94 L (liter) was deaerated, 71.3 kg of 1-hydrotridecafluorohexane (hereinafter referred to as HTH), 20.4 kg of 1,3-dichloro-1,1,2,2,3-pentafluoropropane (AK225cb manufactured by Asahi Glass Company, Limited, hereinafter referred to as AK225cb), 562 g of CH₂═CH(CF₂)₂F and 4.45 g of IAH were charged, the interior of the polymerization tank was heated to 66° C., an initial monomer mixture gas comprising TFE/E in a molar ratio of 89/11 was introduced, and the pressure was elevated to 1.5 MPa/G. 1 L of a 0.7 mass % HTH solution of tert-butylperoxypivarate as a polymerization initiator was charged to initiate polymerization. A monomer mixture gas comprising TFE/E in a molar ratio of 59.5/40.5 was continuously charged so that the pressure would be constant during polymerization. Further, CH₂═CH(CF₂)₂ F in an amount corresponding to 3.3 mol % and IAH in an amount corresponding to 0.8 mol % relative to the total number of moles of TFE and E charged during polymerization were continuously charged.

9.9 hours after initiation of the polymerization, at a time when 7.28 kg of the monomer mixture gas was charged, the internal temperature of the polymerization tank was decreased to room temperature, and the pressure was purged to normal pressure (evacuation) to obtain fluororesin 1. 1/20 of a slurry of fluororesin 1 obtained was poured into a 200 L granulating tank into which 25 kg of artificial sand (ceramic proppant manufactured by Yanagquang Tianchang Ceramic Proppant, 210-420 μm) was charged, and heated to 105° C. with stirring, to coat the surface of the artificial sand with fluororesin 1 while the solvent was removed by evaporation. The obtained artificial sand was dried in a drying furnace at 200° C. for at least 2 hours, followed by cooling to obtain 25 kg of fluororesin-coated sand 1.

The rest of the slurry of fluororesin was poured into a 200 L granulating tank into which 77 kg of water was charged, and heated to 105° C. with stirring for granulation while the solvent was removed by evaporation. The obtained granules were dried at 150° C. for 15 hours to obtain 6.5 kg of granules of fluororesin 1. The copolymer composition of fluororesin 1 was such that the molar ratio of repeating units based on TFE/repeating units based on CH₂═CH(CF₂)₂F/repeating units based on IAH/repeating units based on E was 93.5/5.7/0.8/62.9. The melting point was 230° C., and the Q value was 48 mm³/sec.

Using the obtained fluororesin-coated sand 1, the oil recovery time and the oil recovery amount were measured, whereupon they were 15 minutes and 13 seconds, and 15.2 ml, respectively, and the result of evaluation of the coating adhesion was ◯.

### Example 2

The polymerization tank used in Example 1 was deaerated, 902 kg of AK225cb, 0.216 kg of methanol, 31.6 kg of CF₂═CFOCF₂CF₂CF₃ and 0.43 kg of IAH were charged, the interior of the polymerization tank was heated to 50° C., and TFE was charged until the pressure became 0.38 MPa, 50 ml of a 0.25 mass % AK225cb solution of di(perfluorobutyryl)peroxide as a polymerization initiator solution was charged to initiate polymerization. TFE was continuously charged so that the pressure would be constant during polymerization. The polymerization initiator solution was properly added to maintain the rate of charge of TFE to be substantially constant. 120 ml of the polymerization initiator solution was charged in total. Further, IAH in an amount corresponding to 1 mol % of TFE continuously charged was continuously charged. 6 hours after initiation of polymerization, at a time when 7.0 kg of TFE was charged, the interior of the polymerization tank was cooled to room temperature, and unreacted TFE was purged to obtain fluororesin 2.

1/20 of a slurry of fluororesin 2 obtained was poured into a 200 L granulating tank into which 25 kg of artificial sand (ceramic proppant manufactured by Yanagquang Tianchang Ceramic Proppant, 210-420 μm) was charged, and heated to 105° C. with stirring, to coat the surface of the artificial sand with fluororesin 2 while the solvent was removed by evaporation. The obtained artificial sand was dried in a drying furnace at 300° C. for at least 1 hour, followed by cooling to obtain 26 kg of fluororesin-coated sand 2.

Further, the rest of the slurry of fluororesin 2 was poured into a 200 L granulating tank into which 77 kg of water was charged, and heated to 105° C. with stirring for granulation while the solvent was removed by evaporation. The obtained granules of fluororesin 2 were dried at 150° C. for 15 hours, followed by freeze-grinding to obtain 7.1 kg of a fine powder of fluororesin 2.

The copolymer composition of fluororesin 2 was such that the molar ratio of repeating units based on TFE/repeating units based on CF₂═CFOCF₂CF₂CF₃/repeating units based on IAH was 97.7/2.0/0.3. The melting point was 292° C., and the Q value was 15 mm³/sec.

Using the obtained fluororesin-coated sand 2, the oil recovery time and the oil recovery amount were measured, whereupon they were 16 minutes and 27 seconds, and 16.4 ml, respectively, and the result of evaluation of the coating adhesion was ◯.

### Example 3

The polymerization tank used in Example 1 was deaerated, 87.3 kg of AK225cb and 860 g of CH₂═CH(CF₂)₄F were charged, the interior of the polymerization tank was heated to 66° C. with stirring, a mixture gas comprising TFE/E=89/11 (molar ratio) was introduced until the pressure in the polymerization tank became 1.4 MPaG, and 677 g of a 1 mass % AK225cb solution of tert-butylperoxypivarate as a polymerization initiator was charged to initiate polymerization.

A mixture gas having a composition comprising TFE/E=60/40 (molar ratio) and CH₂═CH(CF₂)₄F in a proportion corresponding to 3.3 mol % relative to the mixture gas were continuously charged so that the pressure would be constant during polymerization. 8 hours after initiation of polymerization, at a time when 7.1 kg of the monomer mixture gas was charged, the internal temperature of the polymerization tank was decreased to room temperature, and the pressure was purged to normal pressure to obtain fluororesin 3.

1/20 of a slurry of fluororesin 3 obtained was poured into a 200 L granulating tank into which 25 kg of artificial sand (ceramic proppant manufactured by Yanagquang Tianchang Ceramic Proppant, 210-420 μm) was charged, and heated to 105° C. with stirring, to coat the surface of the artificial sand with fluororesin 3 while the solvent was removed by evaporation. The obtained artificial sand was dried in a drying furnace at 200° C. for at least 1 hour, followed by cooling to obtain 25 kg of fluororesin-coated sand 3.

Further, the rest of the slurry of fluororesin 3 was poured into a 200 L granulating tank into which 77 kg of water was charged, and heated to 105° C. with stirring for granulation while the solvent was removed by evaporation. The obtained granules were dried at 150° C. for 5 hours to obtain 6.7 kg of granules of fluororesin 3.

The copolymer composition of fluororesin 3 was such that the molar ratio of repeating units based on TFE/repeating units based on E/repeating units based on CH₂═CH(CF₂)₄F was 57.2/40.3/2.5 mol %. Further, the melting point was 223° C., and the Q value was 110 mm³/sec.

Using the obtained fluororesin-coated sand 3, the oil recovery time and the oil recovery amount were measured, whereupon they were 14 minutes and 32 seconds, and 14.5 ml, respectively, and the result of evaluation of the coating adhesion was ◯.

### Comparative Example 1

Using artificial sand (ceramic proppant manufactured by Yanagquang Tianchang Ceramic Proppant, 210-420 μm) not coated with fluororesin, the oil recovery time and the oil recovery amount were measured, whereupon they were 16 minutes and 32 seconds, and 16.0 ml, respectively, and the result of evaluation of the coating adhesion was ◯.

### Comparative Example 2

As a fluororesin, PTFE AD911E manufactured by Asahi Glass Company, Limited was used. The 200 L granulating tank used in Example 1 was filled with 25 kg of AD911E diluted 10-fold with deionized water, and 25 kg of artificial sand (ceramic proppant manufactured by Yanagquang Tianchang Ceramic Proppant, 210-420 μm) was charged to the granulating tank and heated to 150° C. with stirring to coat the surface of the artificial sand with the fluororesin while water was removed by evaporation. The obtained artificial sand was dried in a drying furnace at 350° C. for at least 5 hours, followed by cooling to obtain 26 kg of fluororesin-coated sand 4.

Using the obtained fluororesin-coated sand 4, the oil recovery time and the oil recovery amount were measured, whereupon they were 35 minutes and 30 seconds, and 10.1 ml, respectively, and the result of evaluation of the coating adhesion was ×.

As evident from the above results, the fluororesin-coated proppant of the present invention, as compared with a proppant not coated with a fluororesin, is capable of increasing the amount of recovery of hydrocarbons while shortening the hydrocarbon recovery time from a formation even in a practical process of recovering hydrocarbons from a hydrocarbon-bearing formation through a well, since switching to an oil is quick. Accordingly, in practice, the present invention may bring great economical benefits.

Further, with respect to the type of the coating fluororesin, practical use of conventional PTFE is considered to be difficult since it is hardly melt-formed and has a low adhesion to the surface of proppant particles.

### INDUSTRIAL APPLICABILITY

The well proppant of the present invention has a sufficiently small frictional resistance of the surface and has sufficient durability such as chemical resistance and strength, and is thereby useful for a method of recovering hydrocarbons from a hydrocarbon-bearing formation which has been considered to be difficult (for example, a method of recovering natural gas from a formation containing shale).

This application is a continuation of PCT Application No. PCT/JP2013/072892, filed on August 27, 2013, which is based upon and claims the benefit of priority from Japanese Patent Application No. 2012-206853 filed on September 20, 2012. The contents of those applications are incorporated herein by reference in their entireties.

### REFERENCE SYMBOLS

10: Well

10a: Vertical portion

10b: Horizontal portion

12: Drill tower

14: Hydrocarbon-bearing formation

14a: Fracture

20: Tube filled with proppant

21: Filter

22: High pressure pump

23: Oil

24: Water

25: Scale

26: Trap

27: Vacuum pump

What is claimed is:

1. A well proppant containing fluororesin-coated particles having at least part of the surface of proppant particles coated with a fluororesin (F) having a volume flow rate of from 0.1 to 1,000 mm³/sec.

2. The well proppant according to claim 1, wherein the fluororesin-coated particles are spherical with a sphericity of at least 0.8.

3. The well proppant according to claim 1, wherein the fluororesin-coated particles have an average particle size of from 50 to 1,000 μm.

4. The well proppant according to claim 1, wherein the fluororesin (F) is at least one member selected from the group consisting of a copolymer (F1) having either one or both of structural units based on tetrafluoroethylene and structural units based on chlorotrifluoroethylene, polychlorotrifluoroethylene (F2), polyvinylidene fluoride (F3) and a polymer (F4) having a fluorinated alicyclic structure in its main chain.

5. The well proppant according to claim 4, wherein the copolymer (F1) is at least one member selected from the group consisting of a copolymer having structural units based on tetrafluoroethylene and structural units based on a perfluoro(alkyl vinyl ether), a copolymer having structural units based on tetrafluoroethylene and structural units based on hexafluoropropylene, a copolymer having structural units based on ethylene and structural units based on tetrafluoroethylene, and a copolymer having structural units based on ethylene and structural units based on chlorotrifluoroethylene.

6. The well proppant according to claim 4, wherein the polymer (F4) is a polymer obtainable from at least one monomer selected from the group consisting of the following compounds (6), (7) and (8): 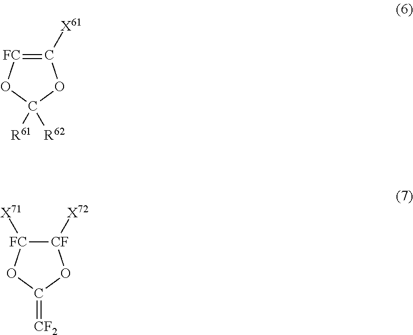
wherein X⁶¹ is a fluorine atom or a C₁₋₃ perfluoroalkoxy group,
each of R⁶¹ and R⁶² which are independent of each other, is a fluorine atom or a C₁₋₆ perfluoroalkyl group, and
each of X⁷¹ and X⁷² which are independent of each other, is a fluorine atom or a C₁₋₉ perfluoroalkyl group;
CF₂═CF-Q-CF═CF₂ (8)
wherein Q is a C₁₋₃ perfluoroalkylene group (which may have an etheric oxygen atom).

7. The well proppant according to claim 1, wherein the fluororesin (F) has at least one type of functional groups selected from the group consisting of a —C(O)O— group, a —OC(O)O— group, a —OH group, a —C(O)OH group, a —C(O)X group (wherein X is a halogen atom) and a C(O)OC(O)— group.

8. The well proppant according to claim 1, wherein the proppant particles are natural sand, artificial sand or resin-coated sand.

9. A method for recovering hydrocarbons, which comprises a step of injecting a fluid containing the well proppant as defined in claim 1, into a hydrocarbon-bearing formation through a well to support fractures in the hydrocarbon-bearing formation by the well proppant, and
a step of recovering hydrocarbons through the well from the hydrocarbon-bearing formation in which the fractures are supported by the well proppant.
